(19) United States
(12) Patent Application Publication
(10) Pub. No.: US 2023/0167783 A1
(43) Pub. Date: Jun. 1, 2023

(54) PROPULSION SYSTEM FOR A GAS TURBINE ENGINE

(71) Applicant: General Electric Company, Schenectady, NY (US)

(72) Inventors: William Joseph Bowden, Cleves, OH (US); Timothy Richard DePuy, Liberty Township, OH (US); Steven B. Morris, Mason, OH (US)

(21) Appl. No.: 17/539,401

(22) Filed: Dec. 1, 2021

(51) Int. Cl. F02K 1/46

(52) U.S. Cl. CPC F02K 1/46; F05D 2250/711; F05D 2250/712; F05D 2220/323; F05D 2240/128; F05D 2250/11; F05D 2250/75

(57) ABSTRACT

A propulsion system is provided. The propulsion system defines a radial direction and includes a rotating element; a stationary element; an inlet assembly defining an inlet positioned between the rotating element and the stationary element and positioned inward of the stationary element along the radial direction, the inlet assembly comprising an inlet duct located downstream of the inlet; and a ducted fan comprising a plurality of fan blades positioned at least partially in the inlet duct; wherein the inlet duct divides into a first duct and a second duct separate from the first duct, wherein the first duct is a core duct downstream of the ducted fan, wherein the second duct is a fan duct downstream of the ducted fan, and wherein the second duct includes an exhaust nozzle having a plurality of chevrons disposed at an aft end of the exhaust nozzle to define an exhaust outlet.

### FIELD

The present subject matter relates generally to a propulsion system for a gas turbine engine.

### BACKGROUND

A gas turbine engine typically includes a fan and a turbomachine. The turbomachine generally includes an inlet, one or more compressors, a combustor, and at least one turbine. The compressors compress air which is channeled to the combustor where it is mixed with fuel. The mixture is then ignited for generating hot combustion gases. The combustion gases are channeled to the turbine(s) which extracts energy from the combustion gases for powering the compressor(s), as well as for producing useful work to propel an aircraft in flight or to power a load, such as an electrical generator.

In a typical turbofan aircraft gas turbine engine application for powering an aircraft in flight, a core exhaust nozzle is used for independently discharging the core exhaust gases inwardly from a concentric fan exhaust nozzle which discharges the fan air therefrom for producing thrust. The separate exhausts from the core nozzle and the fan nozzle are high velocity jets typically having maximum velocity during take-off operation of the aircraft with the engine operated under relatively high power. The high velocity jets interact with each other as well as with the ambient air and may produce substantial noise along the take-off path of the aircraft. The inventors of the present disclosure have found that a system and method for improving a mixing of exhaust from the core exhaust nozzle and the fan exhaust nozzle would be welcomed in the art.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic cross-sectional view of a gas turbine engine in accordance with an exemplary embodiment of the present disclosure.

FIG. 2 is a sectional axial side view of a portion of an exemplary fan duct exhaust nozzle having an exhaust outlet defined by a plurality of adjoining chevrons in accordance with an exemplary embodiment of the present disclosure.

FIG. 3 is an aft facing forward view of a portion of the exhaust nozzle illustrated in FIG. 2 and taken generally along line 3-3 in accordance with an exemplary embodiment of the present disclosure.

FIG. 4 is a perspective view of an exemplary chevron in accordance with an exemplary embodiment of the present disclosure.

FIG. 5 is an axial side view of a portion of an exemplary fan duct exhaust nozzle having an exhaust outlet defined by a plurality of adjoining chevrons in accordance with another exemplary embodiment of the present disclosure.

FIG. 6 is a schematic cross-sectional view of a chevron that is concave or inward penetrating in configuration in accordance with an exemplary embodiment of the present disclosure.

FIG. 7 is a schematic cross-sectional view of chevrons that are concave or inward penetrating in configuration in accordance with an exemplary embodiment of the present disclosure.

FIG. 8 is a schematic cross-sectional view of a chevron that is convex or outward extending in configuration in accordance with an exemplary embodiment of the present disclosure.

FIG. 9 is a schematic cross-sectional view of chevrons that are convex or outward extending in configuration in accordance with an exemplary embodiment of the present disclosure.

FIG. 10 is a schematic cross-sectional view of chevrons having varying lengths in accordance with an exemplary embodiment of the present disclosure.

FIG. 11 is a schematic cross-sectional view of chevrons having varying widths in accordance with an exemplary embodiment of the present disclosure.

Corresponding reference characters indicate corresponding parts throughout the several views. The exemplifications set out herein illustrate exemplary embodiments of the disclosure, and such exemplifications are not to be construed as limiting the scope of the disclosure in any manner.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The following description is provided to enable those skilled in the art to make and use the described embodiments contemplated for carrying out the disclosure. Various modifications, equivalents, variations, and alternatives, however, will remain readily apparent to those skilled in the art. Any and all such modifications, variations, equivalents, and alternatives are intended to fall within the scope of the present disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to a flow in a pathway. For example, with respect to a fluid flow, “upstream” refers to the direction from which the fluid flows, and “downstream” refers to the direction to which the fluid flows. However, the terms “upstream” and “downstream” as used herein may also refer to a flow of electricity.

The term “fluid” may be a gas or a liquid. The term “fluid communication” means that a fluid is capable of making the connection between the areas specified.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, “generally”, and “substantially”, are not to be limited to the precise value specified. In at least some instances, the approximating language may correspond to the precision of an instrument for measuring the value, or the precision of the methods or machines for constructing or manufacturing the components and/or systems. In at least some instances, the approximating language may correspond to the precision of an instrument for measuring the value, or the precision of the methods or machines for constructing or manufacturing the components and/or systems. For example, the approximating language may refer to being within a 1, 2, 4, 5, 10, 15, or 20 percent margin in either individual values, range(s) of values and/or endpoints defining range(s) of values. Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

A “third stream” as used herein means a non-primary air stream capable of increasing fluid energy to produce a minority of total propulsion system thrust. A pressure ratio of the third stream is higher than that of the primary propulsion stream (e.g., a bypass or propeller driven propulsion stream). The thrust may be produced through a dedicated nozzle or through mixing of an airflow through the third stream with a primary propulsion stream or a core air stream, e.g., into a common nozzle.

In certain exemplary embodiments an operating temperature of the airflow through the third stream may be less than a maximum compressor discharge temperature for the engine, and more specifically may be less than 350 degrees Fahrenheit (such as less than 300 degrees Fahrenheit, such as less than 250 degrees Fahrenheit, such as less than 200 degrees Fahrenheit, and at least as great as an ambient temperature). In certain exemplary embodiments these operating temperatures may facilitate heat transfer to or from the airflow through the third stream and a separate fluid stream. Further, in certain exemplary embodiments, the airflow through the third stream may contribute less than 50% of the total engine thrust (and at least, e.g., 2% of the total engine thrust) at a takeoff condition, or more particularly while operating at a rated takeoff power at sea level, static flight speed, 86 degrees Fahrenheit ambient temperature operating conditions. In other exemplary embodiments, it is contemplated that the airflow through the third stream may contribute greater than 50% of the total engine thrust (and at least, e.g., 2% of the total engine thrust) at an engine operating condition. In other exemplary embodiments, it is contemplated that the airflow through the third stream may contribute approximately 50% of the total engine thrust (and at least, e.g., 2% of the total engine thrust) at an engine operating condition.

Furthermore in certain exemplary embodiments, aspects of the airflow through the third stream (e.g., airstream, mixing, or exhaust properties), and thereby the aforementioned exemplary percent contribution to total thrust, may passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

References to “noise”, “noise level”, or “perceived noise”, or variations thereof, are understood to include sound pressure levels (SPL) outside a fuselage, fuselage exterior noise levels, perceived noise levels, effective perceived noise levels (EPNL), instantaneous perceived noise levels (PNL(k)), or tone-corrected perceived noise levels (PNLT(k)), or one or more duration correction factors, tone correction factors, or other applicable factors, as defined by the Federal Aviation Administration (FAA), the European Union Aviation Safety Agency (EASA), the International Civil Aviation Organization (ICAO), Swiss Federal Office of Civil Aviation (FOCA), or committees thereof, or other equivalent regulatory or governing bodies. Where certain ranges of noise levels (e.g., in decibels, or dB) are provided herein, it will be appreciated that one skilled in the art will understand methods for measuring and ascertaining of such levels without ambiguity or undue experimentation. Methods for measuring and ascertaining one or more noise levels as provided herein by one skilled in the art, with reasonable certainty and without undue experimentation, include, but are not limited to, understanding of measurement systems, frames of reference (including, but not limited to, distances, positions, angles, etc.) between the engine and/or aircraft relative to the measurement system or other perceiving body, or atmospheric conditions (including, but not limited to, temperature, humidity, dew point, wind velocity and vector, and points of reference for measurement thereof), as may be defined by the FAA, EASA, ICAO, FOCA, or other regulatory or governing body.

As used herein, the term “community noise” refers to an amount of noise produced by an engine and/or aircraft that is observed on the ground, typically in the community around an airport during a takeoff or landing.

As used herein, the term “third stream” or “mid-fan stream” refers to a stream that flows through an engine inlet and a ducted fan but does not travel through a core inlet and a core duct. Furthermore, the third stream is a stream of air that takes inlet air as opposed to free stream air. The third stream goes through at least one stage of the turbomachine, e.g., the ducted fan.

As used herein, the term “first stream” or “free stream” refers to a stream that flows outside of the engine inlet and over a fan, which is unducted. Furthermore, the first stream is a stream of air that is free stream air.

As used herein, the term “second stream” or “core stream” refers to a stream that flows through the engine inlet and the ducted fan and also travels through the core inlet and the core duct.

In a propulsion system of the present disclosure, a second or fan duct includes an exhaust nozzle having a plurality of chevrons disposed at an aft end of the exhaust nozzle to define an exhaust outlet and a third stream is directed through the chevrons at the aft end of the exhaust nozzle.

The chevrons of the present disclosure promote jet exhaust mixing between adjacent flow streams, e.g., the first stream or prop stream and the third stream or mid-fan stream that travels out the exhaust nozzle of the fan duct having chevrons. Such mixing promoted by the chevrons reduces jet noise, e.g., cabin and community noise, and enables a quieter overall engine and aircraft.

Furthermore, the chevrons of the present disclosure penetrate into the streams to promote mixing and also reduce shock cell noise resulting in cabin noise reduction during high speed cruise conditions

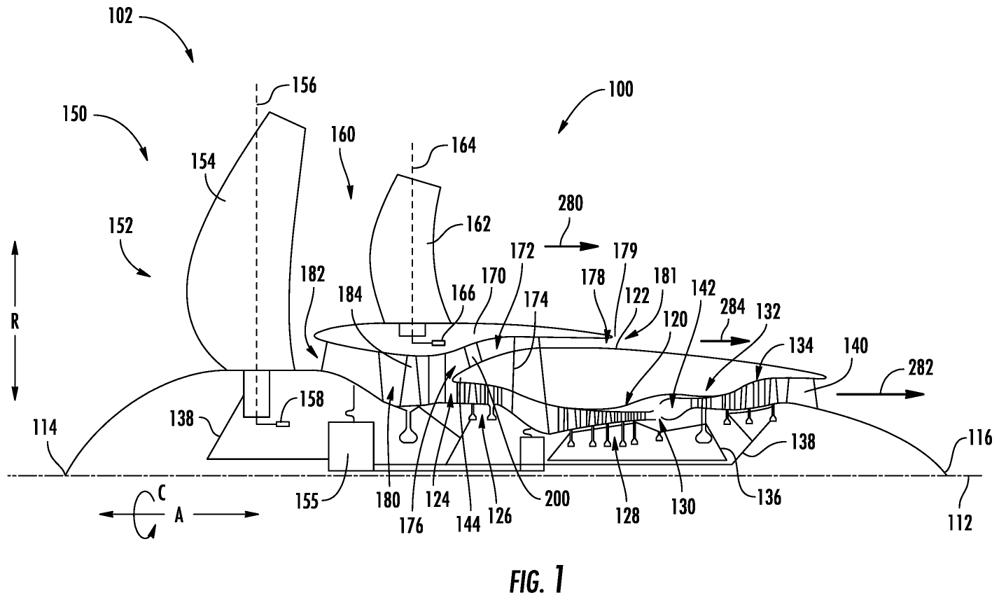

Referring now to FIG. 1, a schematic cross-sectional view of a gas turbine engine 100 is provided according to an example embodiment of the present disclosure. Particularly, FIG. 1 provides an engine having a rotor assembly with a single stage of unducted rotor blades. In such a manner, the rotor assembly may be referred to herein as an “unducted fan,” or the entire engine 100 may be referred to as an “unducted engine,” or an engine having an open rotor propulsion system 102. In addition, the engine of FIG. 1 includes a mid-fan stream extending from the compressor section to a rotor assembly flowpath over the turbomachine, as will be explained in more detail below. It is also contemplated that, in other exemplary embodiments, the present disclosure is compatible with an engine having a duct around the unducted fan. It is also contemplated that, in other exemplary embodiments, the present disclosure is compatible with a turbofan engine having a third stream as described herein.

For reference, the engine 100 defines an axial direction A, a radial direction R, and a circumferential direction C. Moreover, the engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The engine 100 extends between a forward end 114 and an aft end 116, e.g., along the axial direction A.

The engine 100 includes a turbomachine 120, also referred to as a core of the engine 100, and a rotor assembly, also referred to as a fan section 150, positioned upstream thereof. Generally, the turbomachine 120 includes, in serial flow order, a compressor section, a combustion section, a turbine section, and an exhaust section. Particularly, as shown in FIG. 1, the turbomachine 120 includes a core cowl 122 that defines an annular core inlet 124. The core cowl 122 further encloses at least in part a low pressure system and a high pressure system. For example, the core cowl 122 depicted encloses and supports at least in part a booster or low pressure (“LP”) compressor 126 for pressurizing the air that enters the turbomachine 120 through core inlet 124. A high pressure (“HP”), multi-stage, axial-flow compressor 128 receives pressurized air from the LP compressor 126 and further increases the pressure of the air. The pressurized air stream flows downstream to a combustor 130 of the combustion section where fuel is injected into the pressurized air stream and ignited to raise the temperature and energy level of the pressurized air and produce high energy combustion products.

It will be appreciated that as used herein, the terms “high/low speed” and “high/low pressure” are used with respect to the high pressure/high speed system and low pressure/low speed system interchangeably. Further, it will be appreciated that the terms “high” and “low” are used in this same context to distinguish the two systems, and are not meant to imply any absolute speed and/or pressure values.

The high energy combustion products flow from the combustor 130 downstream to a high pressure turbine 132. The high pressure turbine 132 drives the high pressure compressor 128 through a high pressure shaft 136. In this regard, the high pressure turbine 132 is drivingly coupled with the high pressure compressor 128. The high energy combustion products then flow to a low pressure turbine 134. The low pressure turbine 134 drives the low pressure compressor 126 and components of the fan section 150 through a low pressure shaft 138. In this regard, the low pressure turbine 134 is drivingly coupled with the low pressure compressor 126 and components of the fan section 150. The LP shaft 138 is coaxial with the HP shaft 136 in this example embodiment. After driving each of the turbines 132, 134, the combustion products exit the turbomachine 120 through a core or turbomachine exhaust nozzle 140.

Accordingly, the turbomachine 120 defines a working gas flowpath or core duct 142 that extends between the core inlet 124 and the turbomachine exhaust nozzle 140. The core duct 142 is an annular duct positioned generally inward of the core cowl 122 along the radial direction R. The core duct 142 (e.g., the working gas flowpath through the turbomachine 120) may be referred to as a second stream.

The fan section 150 includes a fan 152, which is the primary fan in this example embodiment. For the depicted embodiment of FIG. 1, the fan 152 is an open rotor or unducted fan 152. As depicted, the fan 152 includes an array of fan blades 154 (only one shown in FIG. 1). The fan blades 154 are rotatable, e.g., about the longitudinal axis 112. As noted above, the fan 152 is drivingly coupled with the low pressure turbine 134 via the LP shaft 138. The fan 152 can be directly coupled with the LP shaft 138, e.g., in a direct-drive configuration. However, for the embodiments shown in FIG. 1, the fan 152 is coupled with the LP shaft 138 via a speed reduction gearbox 155, e.g., in an indirect-drive or geared-drive configuration.

Moreover, the fan blades 154 can be arranged in equal spacing around the longitudinal axis 112. Each blade 154 has a root and a tip and a span defined therebetween. Each blade 154 defines a central blade axis 156. For this embodiment, each blade 154 of the fan 152 is rotatable about their respective central blade axis 156, e.g., in unison with one another. One or more actuators 158 are provided to facilitate such rotation and therefore may be used to change a pitch the blades 154 about their respective central blade axis 156.

The fan section 150 further includes a fan guide vane array 160 that includes fan guide vanes 162 (only one shown in FIG. 1) disposed around the longitudinal axis 112. For this embodiment, the fan guide vanes 162 are not rotatable about the longitudinal axis 112. Each fan guide vane 162 has a root and a tip and a span defined therebetween. The fan guide vanes 162 may be unshrouded as shown in FIG. 1 or, alternatively, may be shrouded, e.g., by an annular shroud spaced outward from the tips of the fan guide vanes 162 along the radial direction R or attached to the fan guide vanes 162.

Each fan guide vane 162 defines a central blade axis 164. For this embodiment, each fan guide vane 162 of the fan guide vane array 160 is rotatable about their respective central blade axis 164, e.g., in unison with one another. One or more actuators 166 are provided to facilitate such rotation and therefore may be used to change a pitch of the fan guide vane 162 about their respective central blade axis 164. However, in other embodiments, each fan guide vane 162 may be fixed or unable to be pitched about its central blade axis 164. The fan guide vanes 162 are mounted to a fan cowl 170.

As shown in FIG. 1, in addition to the fan 152, which is unducted, a ducted fan 184 is included aft of the fan 152, such that the engine 100 includes both a ducted and an unducted fan which both serve to generate thrust through the movement of air without passage through at least a portion of the turbomachine 120 (e.g., the HP compressor 128 and combustion section for the embodiment depicted). The ducted fan is shown at about the same axial location as the fan blade 154, and radially inward of the fan blade 154. The ducted fan 184, for the embodiment depicted, is driven by the low pressure turbine 134 (e.g., coupled to the LP shaft 138).

The fan cowl 170 annularly encases at least a portion of the core cowl 122 and is generally positioned outward of at least a portion of the core cowl 122 along the radial direction R. Particularly, a downstream section of the fan cowl 170 extends over a forward portion of the core cowl 122 to define a fan flowpath or fan duct 172. The fan flowpath or fan duct 172 may be referred to as a third stream of the engine 100.

Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The fan cowl 170 and the core cowl 122 are connected together and supported by a plurality of substantially radially-extending, circumferentially-spaced stationary struts 174 (only one shown in FIG. 1). The stationary struts 174 may each be aerodynamically contoured to direct air flowing thereby. Other struts in addition to the stationary struts 174 may be used to connect and support the fan cowl 170 and/or core cowl 122. In many embodiments, the fan duct 172 and the core duct 142 may at least partially co-extend (generally axially) on opposite sides (e.g., opposite radial sides) of the core cowl 122. For example, the fan duct 172 and the core duct 142 may each extend directly from a leading edge 144 of the core cowl 122 and may partially co-extend generally axially on opposite radial sides of the core cowl.

The engine 100 also defines or includes an inlet duct 180. The inlet duct 180 extends between an engine inlet 182 and the core inlet 124/fan duct inlet 176. The engine inlet 182 is defined generally at the forward end of the fan cowl 170 and is positioned between the fan 152 and the array of fan guide vanes 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a splitter or leading edge 144 of the core cowl 122. The inlet duct 180 is wider than the core duct 142 along the radial direction R. The inlet duct 180 is also wider than the fan duct 172 along the radial direction R.

In exemplary embodiments, air passing through the fan duct 172 may be relatively cooler (e.g., lower temperature) than one or more fluids utilized in the turbomachine 120. In this way, one or more heat exchangers 200 may be disposed within the fan duct 172 and utilized to cool one or more fluids from the turbomachine 120, also referred to as a core of the engine 100, with the air passing through the fan duct 172, as a resource for removing heat from a fluid, e.g., compressor bleed air, oil or fuel.

Although not depicted, in certain exemplary embodiments, the engine 100 may further include one or more heat exchangers 200 in other annular ducts or flowpath of the engine 100, such as in the inlet duct 180, in the turbomachinery flowpath/core duct 142, within the turbine section and/or turbomachine exhaust nozzle 140, etc.

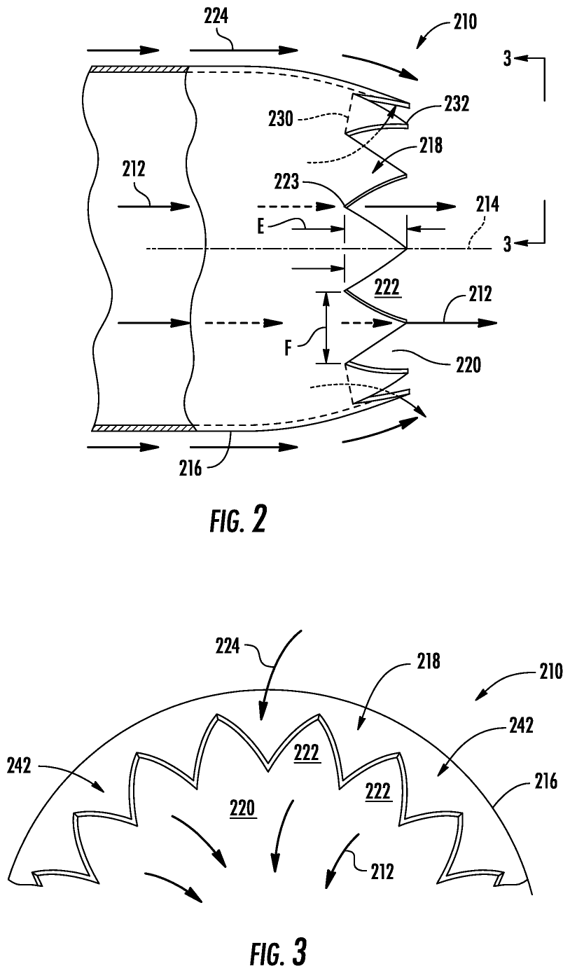

Referring now generally to FIGS. 2 through 11, in exemplary embodiments of the present disclosure, the fan duct 172 includes a fan exhaust nozzle 178 having a plurality of chevrons 218 disposed at an aft end 179 of the fan exhaust nozzle 178 to define an exhaust outlet 181.

As discussed herein, the chevrons 218 of the present disclosure promote jet exhaust mixing between adjacent flow streams, i.e., a first stream or prop stream 280 (FIGS. 1 and 6-9) that travels outside of the engine inlet 182 (FIG. 1) and a third stream or mid-fan stream 284 (FIGS. 1 and 6-9) that travels through the fan duct 172 (FIG. 1) and out the fan exhaust nozzle 178 (FIG. 1) that includes chevrons 218. Such mixing promoted by the chevrons 218 reduces jet noise, e.g., cabin and community noise, and enables a quieter overall engine and aircraft.

As used herein, the term “third stream” or “mid-fan stream” refers to a stream that flows through the engine inlet 182 and the ducted fan 184 but does not travel through the core inlet 124 and the core duct 142. Furthermore, the third stream is a stream of air that takes inlet air as opposed to free stream air. The third stream 284 goes through at least one stage of the turbomachine 120, e.g., the ducted fan 184.

As used herein, the term “first stream” or “free stream” refers to a stream that flows outside of the engine inlet 182 and over the fan 152, which is unducted. Furthermore, the first stream is a stream of air that is free stream air.

As used herein, the term “second stream” or “core stream” refers to a stream that flows through the engine inlet 182 and the ducted fan 184 and also travels through the core inlet 124 and the core duct 142.

Referring now to FIG. 2, a sectional axial side view of a portion of an exemplary fan duct exhaust nozzle 210 having an exhaust outlet 220 defined by a plurality of adjoining chevrons 218 in accordance with an exemplary embodiment of the present disclosure is provided.

Referring to FIG. 2, in an exemplary embodiment, the exhaust nozzle 210 for exhausting a gas jet 212, e.g., a third stream through the fan duct 172 (FIG. 1), from a conventional gas turbine engine (e.g., gas turbine engine 100 shown in FIG. 1) is shown. The exhaust nozzle 210 is axisymmetric about an axial centerline axis 214, and includes an annular exhaust duct 216, e.g., fan duct 172 shown in FIG. 1, for channeling the exhaust gas jet 212 therethrough along the centerline axis 214. The exhaust nozzle 210 also includes a plurality of circumferentially or laterally adjoining chevrons 218 integrally disposed at an aft end of the exhaust duct 216 to define the exhaust outlet 220, e.g., exhaust outlet 181 of fan duct 172 shown in FIG. 1.

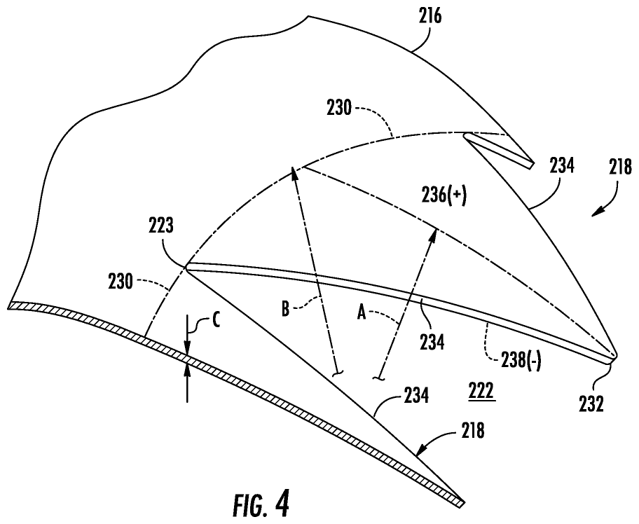

Referring now to FIG. 3, an aft facing forward view of a portion of the exhaust nozzle 210 illustrated in FIG. 2 and taken generally along line 3-3 in accordance with an exemplary embodiment of the present disclosure is provided. Referring now also to FIG. 4, a perspective view of an exemplary chevron 218 in accordance with an exemplary embodiment of the present disclosure is provided.

Referring to FIGS. 3 and 4, in an exemplary embodiment, the plurality of chevrons 218 are each triangular in configuration.

In such a configuration, each chevron 218 includes a base 230 fixedly or integrally joined to an aft end of the exhaust duct 216 circumferentially or laterally coextensively with adjacent chevron bases 230. Each chevron 218 also includes an axially opposite apex 232, and a pair of circumferentially or laterally opposite trailing edges or sides 234 converging from the base 230 to the respective apex 232 in the downstream, aft direction. Each chevron 218 also includes a superior triangular surface 236, and an opposite inferior triangular surface 238 bounded by the trailing edges 234 and base 230.

In an exemplary embodiment, the trailing edges 234 of adjacent chevrons 218 are spaced circumferentially or laterally apart from the bases 230 to apexes 232 to define respective slots or cut-outs 222 diverging laterally and axially, and disposed in flow communication with the inside of the exhaust duct 216 for channeling flow radially therethrough.

Referring to FIGS. 2-4, the slots 222 are also triangular and complementary with the triangular chevrons 218 and diverge axially aft from a slot base 223, which is circumferentially coextensive with the chevrons bases 230 to the chevron apexes 232.

Referring again to FIG. 2, the exhaust gas jet 212 flows inside the exhaust duct 216 and is discharged both axially from its aft exhaust outlet 220 and radially outwardly through the chevron slots 222. The discharged exhaust gas jet 212 may therefore mix with a radially outwardly surrounding outer gas stream 224 which, for example, may be ambient air flowing over the exhaust nozzle 210 either during aircraft ground static or flight, or may alternatively be fan air discharged from the gas turbine engine fan nozzle. Since the exhaust nozzle 210 may be used in various applications, the exhaust gas jet 212 and outer gas stream 224 may be any fluid streams typically found in a gas turbine engine, or in industrial applications involving gas handling and/or discharging apparatus.

Referring now to FIG. 3, in an exemplary embodiment, the plurality of chevrons 218 each have an equal length. Referring still to FIG. 3, in an exemplary embodiment, the plurality of chevrons 218 each have an equal width.

Referring now to FIG. 5, an axial side view of a portion of an exemplary fan duct exhaust nozzle 210 having the exhaust outlet 220 defined by a plurality of adjoining chevrons 218 in accordance with another exemplary embodiment of the present disclosure is provided.

In the exemplary embodiment of FIG. 5, the plurality of chevrons 218 are each scalloped in configuration. For example, each chevron 218 includes a scallop shaped portion 240.

In other exemplary embodiments, it is contemplated that the plurality of chevrons 218 include first chevrons 242 (FIG. 3) having a first geometric shape and second chevrons 244 (FIG. 5) having a second geometric shape different than the first geometric shape. For example, the first chevrons 242 can be triangular in configuration and the second chevrons 244 can be scalloped in configuration.

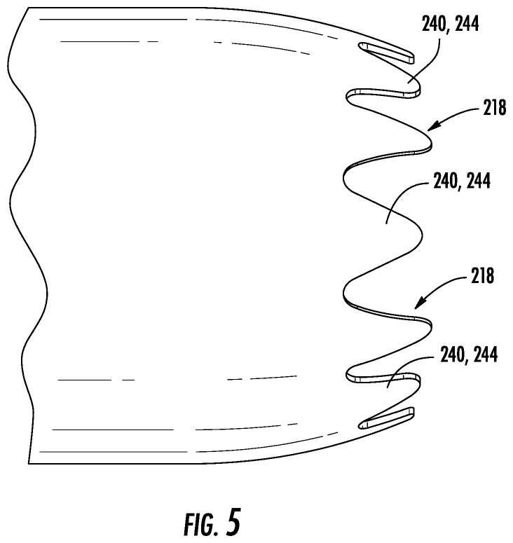

Referring now to FIGS. 6 and 7, simplified, schematic views of the chevron 218 for a fan duct 172 (FIG. 1) that are concave or inward penetrating in configuration in accordance with another exemplary aspect of the present disclosure are provided.

Referring now to FIGS. 4, 6 and 7, in an exemplary embodiment, each chevron 218 has a concave contour axially between the respective bases 230 and apexes 232. The axial contour is defined by a first radius of curvature A (FIG. 4) disposed in the exemplary vertical plane including the centerline axis 214 (FIG. 2). The radius A of the axial contour may vary in magnitude from the chevron base 230 to the chevron apex 232, and in the exemplary embodiment the axial contour is parabolic.

In an exemplary embodiment, the individual chevrons 218 also have a concave contour circumferentially or laterally between the trailing edges 234 as defined by a second radius of curvature B (FIG. 4). The radius B of the lateral contour may also vary along the circumferential arc between the opposite trailing edges 234 of each chevron 218, and preferably provides a smooth surface with the firstly defined axial contours. In this way, the chevron has a compound, three-dimensional flow surface contour defining a shallow concave depression or bowl for promoting mixing effectiveness. The compound curvatures may be defined by simple circular arcs, or by parabolic curves, or by higher order quadratic curves.

In an exemplary embodiment, the chevrons 218 have a substantially uniform thickness C (FIG. 4) which may also be equal to the thickness of the exhaust duct 216 (FIG. 2) from which they extend, and may be formed of one or more thin walled members or plates. Alternatively, the chevrons may vary in thickness to allow for structural rigidity and flow surface blending. In the exemplary embodiment illustrated in FIG. 4, the chevron superior triangular surface 236 is convex as represented by the plus sign (+), with the chevron inferior triangular surface 238 being concave as represented by the minus sign (−).

Although the individual chevrons 218, for example, could be flat components suitably inclined to define either a converging or diverging nozzle, the chevrons 218 have a slight, compound curvature for cooperating with the gas flow for promoting mixing effectiveness while at the same time providing an aerodynamically smooth and non-disruptive profile for minimizing losses in aerodynamic efficiency and performance.

For example, in the embodiment illustrated in FIG. 4, the superior triangular surface 236 is disposed radially outwardly of the inferior triangular surface 238 with the superior triangular surface 236 being convex, and the inferior triangular surface 238 being concave. The chevrons 218 and cooperating slots 222 are generally laterally or circumferentially coextensive with each other at generally common radii from the bases 230 to the apexes 232 for minimizing or reducing radial projection of the chevrons 218 into the exhaust gas jet 212. In the exemplary embodiment illustrated in FIGS. 2-4, the exhaust nozzle 210 is configured as a converging nozzle of decreasing flow area with an effective throat of minimum flow area being defined at a suitable location between the chevron bases 230 and apexes 232. The individual chevrons 218 are therefore inclined radially inwardly from their forward bases 230 to their aft apexes 232 and thusly confine the exhaust gas jet 212 radially therebelow. However, the slots 222 allow the exhaust gas jet 212 to expand radially outwardly therethrough for promoting forced mixing.

As shown in FIG. 7, a chevron 218 of the present disclosure can have a concave contour of a varying depth. For example, a first chevron 310 may inwardly penetrate a first distance D1 from a chevron centerline 305 and a second chevron 312 may inwardly penetrate a second distance D2 from the chevron centerline 305. As shown in FIG. 7, the second distance D2 is greater than the first distance D1.

Referring to FIGS. 6 and 7, two of the three streams of an unducted fan open rotor are shown. For example, illustrated are the first stream or prop stream 280 and the third stream or mid-fan stream 284. In the exemplary embodiment depicted, the first stream 280 travels outside of the engine inlet 182 (FIG. 1). Furthermore, the third stream 284 travels through the fan duct 172 (FIG. 1) and out the fan exhaust nozzle 178 (FIG. 1) that includes chevrons 218. Referring to FIG. 1, the second stream or core stream 282 is also shown along with the first stream 280 and the third stream 284.

Referring to FIGS. 6 and 7, in an exemplary embodiment, the chevrons 218 that are concave or inward penetrating in configuration promote jet exhaust mixing between adjacent flow streams, i.e., the first stream or prop stream 280 that travels outside of the engine inlet 182 (FIG. 1) and the third stream or mid-fan stream 284 that travels through the fan duct 172 (FIG. 1) and out the fan exhaust nozzle 178 (FIG. 1) that includes chevrons 218. Such mixing promoted by chevrons 218 reduces jet noise, e.g., cabin and community noise, and enables a quieter overall engine and aircraft.

Furthermore, the chevrons 218 of the present disclosure penetrate into the streams 280, 284 to promote mixing and also reduce shock cell noise resulting in cabin noise reduction during high speed cruise conditions.

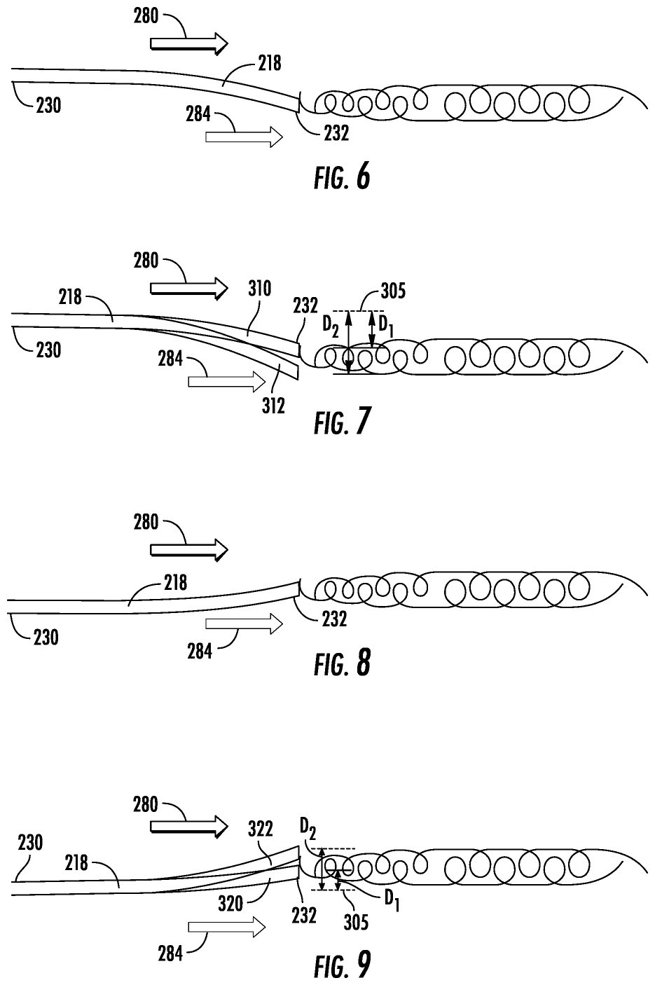

Referring now to FIGS. 8 and 9, simplified, schematic views of a chevron 218 for a fan duct 172 (FIG. 1) that are convex or outward extending in configuration in accordance with another exemplary aspect of the present disclosure are provided.

In an exemplary embodiment, each chevron 218 has a convex contour axially between the respective bases 230 and apexes 232.

As shown in FIG. 9, a chevron 218 of the present disclosure can have a convex contour of a varying depth. For example, a first chevron 320 may outwardly extend a first distance D1 from a chevron centerline 305 and a second chevron 322 may outwardly extend a second distance D2 from the chevron centerline 305. As shown in FIG. 9, the second distance D2 is greater than the first distance D1.

Referring to FIGS. 8 and 9, two of the three streams of an unducted fan open rotor are shown. For example, illustrated are the first stream or prop stream 280 and the third stream or mid-fan stream 284. In the exemplary embodiment depicted, the first stream 280 travels outside of the engine inlet 182 (FIG. 1). Furthermore, the third stream 284 travels through the fan duct 172 (FIG. 1) and out the fan exhaust nozzle 178 (FIG. 1) that includes chevrons 218. Referring to FIG. 1, the second stream or core stream 282 is also shown along with the first stream 280 and the third stream 284.

Referring to FIGS. 8 and 9, in an exemplary embodiment, the chevrons 218 that are convex or outward extending in configuration promote jet exhaust mixing between adjacent flow streams, i.e., the first stream or prop stream 280 that travels outside of the engine inlet 182 (FIG. 1) and the third stream or mid-fan stream 284 that travels through the fan duct 172 (FIG. 1) and out the fan exhaust nozzle 178 (FIG. 1) that includes chevrons 218. Such mixing promoted by chevrons 218 reduces jet noise, e.g., cabin and community noise, and enables a quieter overall engine and aircraft.

Furthermore, the chevrons 218 of the present disclosure penetrate into the streams 280, 284 to promote mixing and also reduce shock cell noise resulting in cabin noise reduction during high speed cruise conditions.

In other exemplary embodiments, it is contemplated that the plurality of chevrons 218 include first chevrons that are concave or inward penetrating in configuration (FIGS. 6 and 7) and second chevrons that are convex or outward extending in configuration (FIGS. 8 and 9). In such an embodiment, the chevrons 218 could be configured in an alternating concave and convex chevron pattern.

Referring now to FIG. 10, a simplified, schematic view of a plurality of chevrons 218 for a fan duct 172 (FIG. 1) having varying lengths in accordance with another exemplary aspect of the present disclosure is provided.

Referring to FIG. 10, in an exemplary embodiment, the plurality of chevrons 218 include first chevrons 270 having a first length L1 and second chevrons 272 having a second length L2 different than the first length L1. In an exemplary embodiment, the plurality of chevrons 218 further include third chevrons 274 having a third length L3 different than the second length L2.

In an exemplary embodiment, the first length L1 is greater than the second length L2 and the third length L3. Furthermore, the second length L2 is greater than the third length L3 as shown in FIG. 10.

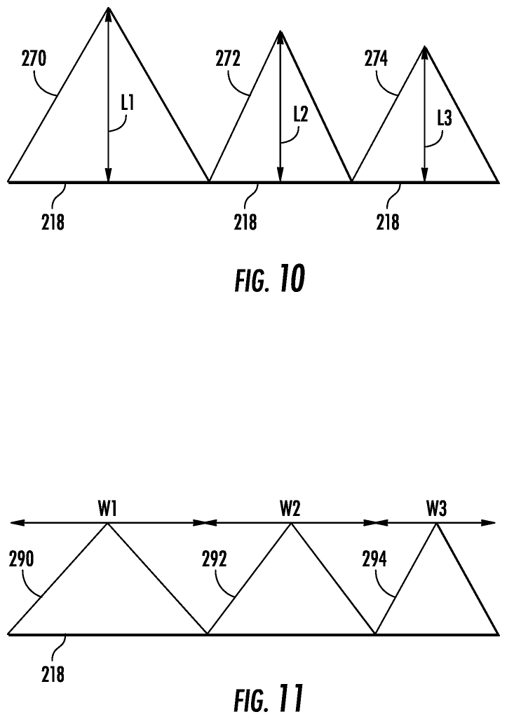

Referring now to FIG. 11, a simplified, schematic view of a plurality of chevrons 218 for a fan duct 172 (FIG. 1) having varying widths in accordance with another exemplary aspect of the present disclosure is provided.

In an exemplary embodiment, the plurality of chevrons 218 include first chevrons 290 having a first width W1 and second chevrons 292 having a second width W2 different than the first width W1. In an exemplary embodiment, the plurality of chevrons 218 further include third chevrons 294 having a third width W3 different than the second width W2.

In an exemplary embodiment, the first width W1 is greater than the second width W2 and the third width W3. Furthermore, the second width W2 is greater than the third width W3, as shown in FIG. 11.

In an exemplary aspect of the present disclosure, a method of operating a propulsion system includes operating a first rotating fan assembly to produce a first stream of air; directing a portion of the first stream of air into a second ducted rotating fan assembly; operating the second ducted rotating fan assembly to produce a second stream of air; dividing the second stream of air into a core stream and a fan stream; directing the core stream into a gas turbine engine core; and directing the fan stream through a duct including an exhaust nozzle having a plurality of chevrons disposed at an aft end of the exhaust nozzle to define an exhaust outlet.

Further aspects are provided by the subject matter of the following clauses:

A propulsion system defining a radial direction, comprising: a rotating element; a stationary element; an inlet assembly defining an inlet positioned between the rotating element and the stationary element and positioned inward of the stationary element along the radial direction, the inlet assembly comprising an inlet duct located downstream of the inlet; and a ducted fan comprising a plurality of fan blades positioned at least partially in the inlet duct; wherein the inlet duct divides into a first duct and a second duct separate from the first duct, wherein the first duct is a core duct downstream of the ducted fan, wherein the second duct is a fan duct downstream of the ducted fan, wherein the second duct is outward of the first duct along the radial direction, and wherein the second duct includes an exhaust nozzle having a plurality of chevrons disposed at an aft end of the exhaust nozzle to define an exhaust outlet.

The propulsion system of one or more of these clauses, wherein the plurality of chevrons are each triangular in configuration.

The propulsion system of one or more of these clauses, wherein the plurality of chevrons are each scalloped in configuration.

The propulsion system of one or more of these clauses, wherein the plurality of chevrons include first chevrons having a first geometric shape and second chevrons having a second geometric shape different than the first geometric shape.

The propulsion system of one or more of these clauses, wherein the plurality of chevrons are each concave in configuration.

The propulsion system of one or more of these clauses, wherein the plurality of chevrons are each convex in configuration.

The propulsion system of one or more of these clauses, wherein the plurality of chevrons include first chevrons that are concave in configuration and second chevrons that are convex in configuration.

The propulsion system of one or more of these clauses, wherein the plurality of chevrons each have an equal length.

The propulsion system of one or more of these clauses, wherein the plurality of chevrons include first chevrons having a first length and second chevrons having a second length different than the first length.

The propulsion system of one or more of these clauses, wherein the plurality of chevrons each have an equal base width.

The propulsion system of one or more of these clauses, wherein the plurality of chevrons include first chevrons having a first width and second chevrons having a second width different than the first width.

The propulsion system of one or more of these clauses, wherein the rotating element is an unducted rotating element.

The propulsion system of one or more of these clauses, wherein the rotating element has an axis of rotation and a plurality of blades, wherein the stationary element has a plurality of vanes, and wherein the plurality of vanes do not rotate about the axis of rotation.

The propulsion system of one or more of these clauses, wherein the first duct fluidly communicates with a core of a gas turbine engine.

The propulsion system of one or more of these clauses, wherein the core of the gas turbine engine includes a core exhaust nozzle, and wherein the first duct includes the core exhaust nozzle.

The propulsion system of one or more of these clauses, wherein the exhaust nozzle is a fan nozzle separate and spaced from the core exhaust nozzle.

An inlet assembly for an aircraft having a propulsion system defining a radial direction, the propulsion system including a rotating element and a stationary element, the inlet assembly defining an inlet positioned between the rotating element and the stationary element and positioned inward of the stationary element along the radial direction, the inlet assembly comprising: an inlet duct located downstream of the inlet; and a ducted fan comprising a plurality of fan blades positioned at least partially in the inlet duct; wherein the inlet duct divides into a first duct and a second duct separate from the first duct, wherein the first duct is a core duct downstream of the ducted fan, wherein the second duct is a fan duct downstream of the ducted fan, wherein the second duct is outward of the first duct along the radial direction, and wherein the second duct includes an exhaust nozzle having a plurality of chevrons disposed at an aft end of the exhaust nozzle to define an exhaust outlet.

The inlet assembly of one or more of these clauses, wherein the plurality of chevrons are each triangular in configuration.

The inlet assembly of one or more of these clauses, wherein the plurality of chevrons are each scalloped in configuration.

A method of operating a propulsion system, comprising: operating a first rotating fan assembly to produce a first stream of air; directing a portion of the first stream of air into a second ducted rotating fan assembly; operating the second ducted rotating fan assembly to produce a second stream of air; dividing the second stream of air into a core stream and a fan stream; directing the core stream into a core of a gas turbine engine; and directing the fan stream through a duct including an exhaust nozzle having a plurality of chevrons disposed at an aft end of the exhaust nozzle to define an exhaust outlet.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

While this disclosure has been described as having exemplary designs, the present disclosure can be further modified within the scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A propulsion system defining a radial direction, comprising:
a rotating element;
a stationary element;
an inlet assembly defining an inlet positioned between the rotating element and the stationary element and positioned inward of the stationary element along the radial direction, the inlet assembly comprising an inlet duct located downstream of the inlet; and
a ducted fan comprising a plurality of fan blades positioned at least partially in the inlet duct;
wherein the inlet duct divides into a first duct and a second duct separate from the first duct,
wherein the first duct is a core duct downstream of the ducted fan, wherein the second duct is a fan duct downstream of the ducted fan, wherein the second duct is outward of the first duct along the radial direction, and
wherein the second duct includes an exhaust nozzle having a plurality of chevrons disposed at an aft end of the exhaust nozzle to define an exhaust outlet, wherein the plurality of chevrons include first chevrons having a first geometric shape and second chevrons having a second geometric shape different than the first geometric shape.

2. The propulsion system of claim 1, wherein a portion of the plurality of chevrons are triangular.

3. The propulsion system of claim 1, wherein a portion of the plurality of chevrons are scalloped.

4. (canceled)

5. The propulsion system of claim 1, wherein a portion of the plurality of chevrons are concave.

6. The propulsion system of claim 1, wherein a portion of the plurality of chevrons are convex.

7. (canceled)

8. The propulsion system of claim 1, wherein the plurality of chevrons each have an equal length.

9. The propulsion system of claim 1, wherein the first chevrons have a first length and the second chevrons have a second length different than the first length.

10. The propulsion system of claim 2, wherein the plurality of chevrons each have an equal base width.

11. The propulsion system of claim 1, wherein the first chevrons have a first width and the second chevrons have a second width different than the first width.

12. The propulsion system of claim 1, wherein the rotating element is an unducted rotating element.

13. The propulsion system of claim 1, wherein the rotating element has an axis of rotation and a plurality of blades, wherein the stationary element has a plurality of vanes, and wherein the plurality of vanes do not rotate about the axis of rotation.

14. The propulsion system of claim 1, wherein the first duct fluidly communicates with a core of a gas turbine engine.

15. The propulsion system of claim 14, wherein the core of the gas turbine engine includes a core exhaust nozzle, and wherein the first duct includes the core exhaust nozzle.

16. The propulsion system of claim 15, wherein the exhaust nozzle is a fan nozzle separate and spaced from the core exhaust nozzle.

17. An inlet assembly for an aircraft having a propulsion system defining a radial direction, the propulsion system including a rotating element and a stationary element, the inlet assembly defining an inlet positioned between the rotating element and the stationary element and positioned inward of the stationary element along the radial direction, the inlet assembly comprising:
an inlet duct located downstream of the inlet; and
a ducted fan comprising a plurality of fan blades positioned at least partially in the inlet duct;
wherein the inlet duct divides into a first duct and a second duct separate from the first duct, wherein the first duct is a core duct downstream of the ducted fan, wherein the second duct is a fan duct downstream of the ducted fan, wherein the second duct is outward of the first duct along the radial direction, and wherein the second duct includes an exhaust nozzle having a plurality of chevrons disposed at an aft end of the exhaust nozzle to define an exhaust outlet, wherein the plurality of chevrons include first chevrons having a first geometric shape and second chevrons having a second geometric shape different than the first geometric shape.

18. The inlet assembly of claim 17, wherein a portion of the plurality of chevrons are triangular.

19. The inlet assembly of claim 17, wherein a portion of the plurality of chevrons are scalloped.

20. A method of operating a propulsion system, comprising:
operating a first rotating fan assembly to produce a first stream of air;
directing a portion of the first stream of air into a second ducted rotating fan assembly;
operating the second ducted rotating fan assembly to produce a second stream of air;
dividing the second stream of air into a core stream and a fan stream;
directing the core stream into a core of a gas turbine engine; and
directing the fan stream through a duct including an exhaust nozzle having a plurality of chevrons disposed at an aft end of the exhaust nozzle to define an exhaust outlet, wherein the plurality of chevrons include first chevrons having a first geometric shape and second chevrons having a second geometric shape different than the first geometric shape.
